(19) United States
(12) Patent Application Publication
(10) Pub. No.: US 2010/0123391 A1
(43) Pub. Date: May 20, 2010

(54) Lamp

(76) Inventors: Arturo De Santiago, Cd. Juarez Chihuahua (MX); Victor Cordero, Cd. Juarez Chihuahua (MX); Laura Hernandez, Cd. Juarez Chihuahua (MX)

Correspondence Address: OSRAM SYLVANIA INC, 100 ENDICOTT STREET, DANVERS, MA, 01923, US

(21) Appl. No.: 12/313,132

(22) Filed: Nov. 17, 2008

(51) Int. Cl. H01K 1/50

(52) U.S. Cl. 313/579

(57) ABSTRACT

A method of making a cycleable, tungsten-halogen heat lamp for outputting a given amount of heat from a lamp envelope of given volume comprises the steps of designing a tungsten, incandescent coil capable of generating a given amount of heat, the coil to have a given number of secondary turns and a life time including a given number of cycles; and reducing the given number of secondary turns by one by increasing the diameter of the coil, whereby the given number of cycles of the lamp is increased by 100%. In practice the given number of cycles is in the range of 6800 to 7500 and the increased number of cycles is in the range of 15000. The lamp (10) comprises a glass envelope (12) for example, of quartz or similar material having an inside diameter of X inches. A tungsten coil 14 is positioned within the envelope (12). The tungsten coil (14) has a major diameter Y that is greater than 50% of the inside diameter X.

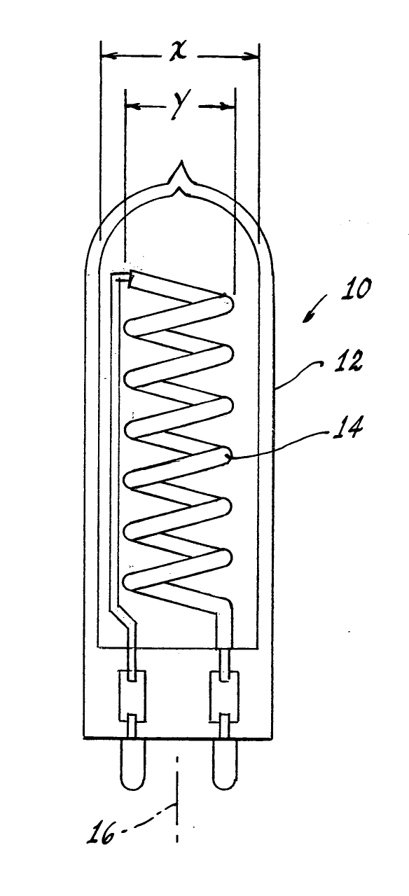

### TECHNICAL FIELD

This invention relates to incandescent lamps and more to particularly to such lamps that are use for thermal processing. Still more particularly, it relates to thermal processing lamps having reduced filament sag and long life.

### BACKGROUND ART

Incandescent lamps are often employed for the heat generated by the filament, as opposed to the light output derived therefrom. In such lamps it is usual for the lamp to be cycled on and off during its use, that is, the lamp is not always in the “on” mode. Partially because of the temperature at which the lamps operate and partially because of the mode of operation, the filaments are subject to sagging and, when the “sag” becomes severe enough to cause the coils to the filament to contact one another, the lamp fails. Prior attempts to solve the sagging problem have contemplated advanced materials for the filament (for example, the use of phosphorus on the filament, U.S. Pat. No. 3,989,549) and the use of internal supports (U.S. Pat. Nos. 3,789,255; 3,850,489; 4,208,606; 4,935,662). While each of these techniques provided some benefit, they were expensive or difficult to employ and did not seriously lengthen the life of the lamp.

### DISCLOSURE OF INVENTION

It is, therefore, an object of the invention to obviate the disadvantages of the prior art.

It is another object of invention of enhance heat lamps.

Yet other objects of the invention are the improvement of the performance and life of such lamps and the provision of a method of making such a lamp.

These objects are accomplished, in one aspect of the invention by the provision of a tungsten-halogen lamp comprising: a glass envelope having an inside diameter of 0.346±0.010 inches; and a tungsten coil within said envelope, the tungsten coil having a major diameter that is greater than 50% of said inside diameter.

The method comprises the steps of designing a tungsten, incandescent coil capable of generating a given amount of heat, the coil to have a given number of secondary turns and a life time including a given number of cycles; and reducing said given number of secondary turns by one by increasing the diameter of the coil, whereby the given number of cycles of the lamp is increased by 100%.

This expedient removes the need for additional inside supports for the filament and yet allows the lamp to operate at its designed temperature for extended periods of time. No additional materials are utilized and, therefore, the cost is critically controlled.

### BRIEF DESCRIPTION OF THE DRAWINGS

The single FIGURE is a diagrammatic representation of a lamp according to an aspect of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

Referring now to the drawing with greater particularity, a lamp 10, for example, a tungsten halogen lamp, has a glass envelope 12 of a suitable material, such as quartz with an inside diameter of 0.346 inches±0.010 inches and contains a coil 14 extending along the longitudinal axis 16 of the lamp. The coil 14 can be a coiled-coil or a triple coil that has been designed to produce a given amount of heat while it is being cycled on and off. Such lamps are used often in manufacturing processes where heat is desired. After the initial design, the coil will have a given amount of wire and a given number of secondary turns and a given diameter. Maintaining the same length of wire, the coil is redesigned to have a larger diameter and one secondary turn less than the original design, thus increasing the spacing between the turns. The new coil will have a major diameter Y that is greater than 50% of the inside diameter X of the lamp envelope and preferably is about 0.225 inches. The coil wire diameter is preferably about 0.040 inches. When the latter coil is used, it is found that the number of cycles the lamp is capable of operating without failure has increased from 6,800 cycles to 15,000 cycles. Envelope size and all other material costs remain the same as the original lamp and the coil functions far longer without sag and without the inclusion of additional supports.

While there have been shown and described what are at present considered to be the preferred embodiments of the invention, it will be apparent to those skilled in the art that various changes and modifications can be made herein without departing from the scope of the invention as defined by the appended claims.

What is claimed is:

1. A method of making a cycleable, tungsten-halogen heat lamp for outputting a given amount of heat from a lamp envelope of given volume comprising the steps of:
designing a tungsten, incandescent coil capable of generating said given amount of heat, said coil to have a given number of secondary turns and a life time including a given number of cycles; and
reducing said given number of secondary turns by one by increasing the diameter of said coil, whereby said given number of cycles of said lamp is increased by 100%.

2. The method of claim 1 wherein said given number of cycles is in the range of 6800 to 7500 and said increased number of cycles is in the range of 15000.

3. A tungsten-halogen lamp comprising:
a glass envelope having an inside diameter X;
a tungsten coil within said envelope, said tungsten coil having a major diameter Y that is greater than 50% of said inside diameter X.

4. The tungsten-halogen lamp 10 of claim 4 wherein X is equal to about 0.346 inches.

5. The tungsten-halogen lamp of claim 4 wherein the major diameter Y is about 0.225 inches.
